(19) United States
(12) Patent Application Publication
(10) Pub. No.: US 2014/0172628 A1
(43) Pub. Date: Jun. 19, 2014

(54) Approximating Customer Location Within A Store

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/718,990

(22) Filed: Dec. 18, 2012

(51) Int. Cl. G06Q 30/06

(52) U.S. Cl. CPC G06Q 30/0633
USPC 705/26.8

(57) ABSTRACT

The present invention extends to methods, systems, and computer program products approximating customer location within a store. Consumers can load a shopping list onto a mobile device. The mobile device can communicate via wireless communication with a customer location server. The customer location server can contain a map of a store as well as the location of items for sale within the store. The mobile device can send a notification to the customer location server when an item has been checked off of the mobile device shopping list. The customer location server can determine the location of the item that was checked off of the mobile device shopping list. The customer location server can infer that the customer is near the location of the item that was checked off of the mobile device shopping list.

### CROSS-REFERENCE TO RELATED APPLICATIONS

Not applicable.

### BACKGROUND

1. Field of the Invention

This invention relates generally to the field of device location, and, more particularly, to locating a customer within a store.

2. Related Art

In a variety of scenarios related to consumer goods and/or retail products, consumers or buyers of goods may have a desire to purchase multiple items; either from one store or from multiple stores. In order to make sure the consumer does not forget the items they intend to buy, a common practice is to create a list itemizing the products or services the consumer is interested in purchasing. This list, commonly referred to as a shopping list, can be used to remind the consumer regarding which items the consumer intends to purchase.

A practice that is becoming more and more common is to create shopping lists in a digital format. For example, consumers can create shopping lists on their computer or on their mobile devices (e.g., smartphones). One advantage of having a shopping list on a mobile device is that the consumer is more likely to have their mobile device in their possession during the course of a day. As items come to the consumers mind, the consumer can add to or remove items from the shopping list on their mobile device. Furthermore, as the consumer goes shopping, the consumer can check items off of the shopping list as the items are retrieved.

Retail stores have an interest in the shopping patterns and needs of their customers. As a retail store learns about the habits and tendencies of its customers, it can offer incentives such as coupons or rebates to entice its customers to make more purchases or purchase items that may be unfamiliar to a customer; thereby improving the shopping experience of the customer and increasing the profit margin of the store. One way that a store observes the shopping habits of its customers is issuing a membership card to its customers. As the customer checks out, the customer card is scanned. The store database can then keep track of which items the customer purchases, and how often the purchases are made. The store incentivizes the customer to use the card by offering reduced prices for purchases made with the card.

This approach of assigning membership cards is an effective method of monitoring customer purchases. One limitation of the membership card approach, however, is that many customers may choose not to utilize a membership card while they are shopping. Another limitation is that the store is only able to determine what the customer has purchased after the purchase is made. However, the store has little, if any, way to know how a customer went about locating and retrieving purchased items within the store.

### BRIEF DESCRIPTION OF THE DRAWINGS

The specific features, aspects and advantages of the present invention will become better understood with regard to the following description and accompanying drawings where:

FIG. 1 illustrates an example block diagram of a computing device.

FIG. 2 illustrates an example computer architecture that facilitates approximating customer location within a store.

FIG. 3 illustrates a flow chart of an example method for approximating customer location within a store.

FIG. 4 illustrates another computer architecture that facilitates approximating customer location within a store.

### DETAILED DESCRIPTION

The present invention extends to methods, systems, and computer program products for approximating customer location within a store. In the following description of the present invention, reference is made to the accompanying drawings, which form a part hereof, and in which is shown by way of illustration specific embodiments in which the invention may be practiced. It is understood that other embodiments may be utilized and structural changes may be made without departing from the scope of the present invention.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

In this description and in the following claims, an “application ID” is defined as an identifier used to match a mobile device to a shopping list. An application ID can be a shopping list ID, a mobile device ID, an account ID, a session ID, a user name, an application specific ID, an ID from a device keychain, any other token as well as a combination of one of more of these.

In general, embodiments of the invention are directed to approximating customer location within a store. A customer location server has access to a store layout (map) of the store. The customer location server also has access to an item database. The item database maps items for sale at the store to their corresponding location within the store.

A mobile device contains a shopping list management module. The shopping list management module can maintain a customer shopping list. As the customer retrieves an item within the store, the customer can check off the item on the shopping list. In response to the customer checking off the item, the mobile device can use wireless communication to send a notification to the customer location server that the item has been checked off. The notification can include an application ID of the shopping list management module as well as data identifying the item that was checked off of the customer shopping list. Identifying data can include one or more of: an item ID, an item type, and a textual item description.

In some embodiments, items can be added a shopping using freehand text. Alternately or in combination, items can be added to shopping list by selecting products identified in other lists, such as, for example, search results, digital receipts, digital receipt history, electronic coupons, etc.

Upon receiving the notification from the customer mobile device, the customer location server can refer to an appropriate database and to a store layout (map) to determine the location of the checked off item within the store. When a received notification includes an item ID, the customer location server can refer directly to the item database to obtain item location in any appropriate form. When a received notification includes descriptive text or an item type for an item, the customer location server can refer to an item type database to obtain item location. The customer location server infers that the customer was near the location of the checked off item when the item was checked off of the shopping list.

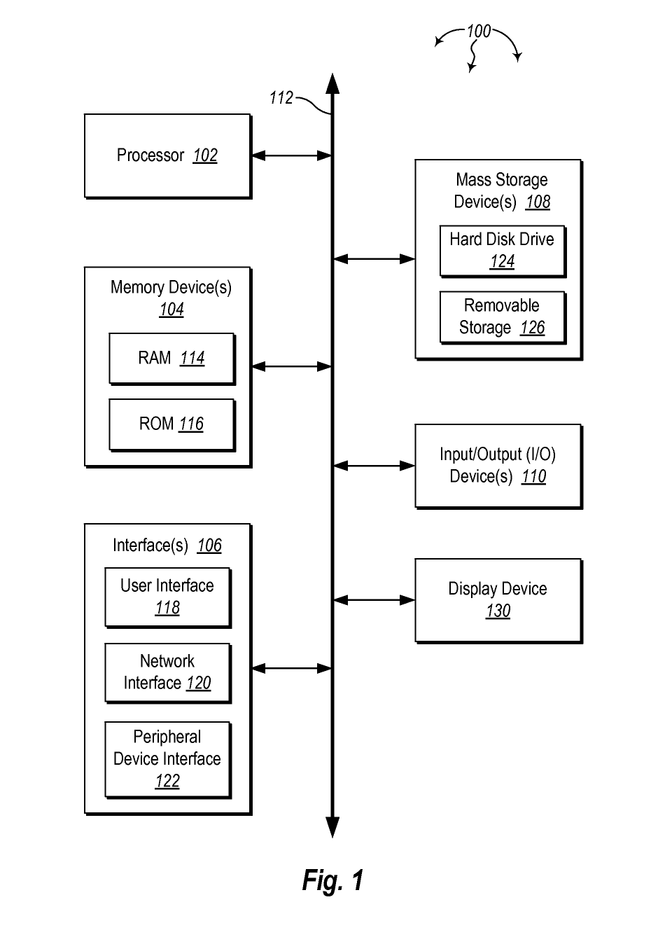

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc, networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

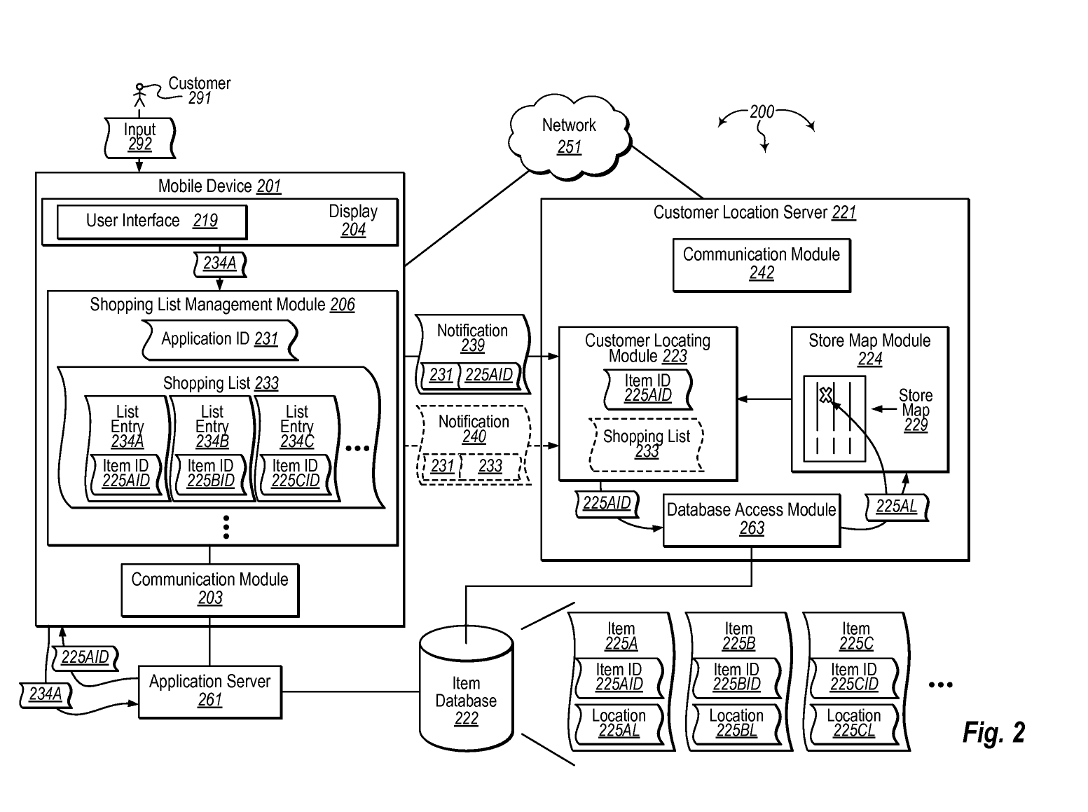

FIG. 2 illustrates an example computer architecture 200 that facilitates approximating customer location within a store. Referring to FIG. 2, computer architecture 200 includes mobile device 201, customer location server 221, item database 222, and application server 261. Each of mobile device 201, customer location server 221, item database 222, and application server 261 as well as their respective components can be connected to one another over (or be part of) a network, such as, for example, a PAN, a LAN, a WAN, and even the Internet. Accordingly, each of mobile device 201, customer location server 221, item database 222, and application server 261 as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

In general, customer location server 221 is configured to infer a customer location within a store. Customer location server 221 includes communication module 242, customer locating module 223, store map module 224, and database access module 263. Communication module 242 can be a wireless network adapter for connecting customer location server 221 to network 251, such as, for example, a Wi-Fi network, within a store.

Customer locating module 223 is configured to receive notifications of items checked off shopping lists. Customer locating module 223 can refer to item database 222 (through database access module 263) to identify a corresponding location for an item. Store map module 224 can then identify the item location on map 229. An item location can be identified using any appropriate mechanisms in the art of indoor mapping, such as, for example, grid reference. Store map module 224 can send the identified item location back to customer locating module 223. Customer locating module can infer that a customer is at or near to an identified item location based on an item being checked off a shopping list.

In some embodiments, store map module 224 processes item locations for a single store. Thus, store map 229 may be the only map that store map module 224 processes. In other embodiments, store map module 223 processes item locations for multiple stores. Each store may have items in different locations. In these other embodiments, store maps can be associated with a store id that identifies the store corresponding to the store map.

Store map module 224 can maintain store map 229 (or layout) of the store, including, but not limited to, the number and location of aisles, the location of point of sale systems, the location of departments, etc. Database access module 263 is configured to maintain (e.g., access, store, update, etc.) data in item database 222. Item database 222 can contain item information, including item name, item description, item ID, and item location information (i.e., where the item is located in the store) for items within the store.

For example, item database 222 can include item information for items 225A, 225B, and 225C. Item information for item 225A includes item ID 225AID and location 225AL (the location of item 225A within the store). Item information for item 225B includes item ID 225BID and location 225BL (the location of item 225B within the store). Item information for item 225C includes item ID 225CID and location 225CL (the location of item 225C within the store).

Mobile device 201 (e.g., a smartphone) includes communication module 203, display 204, and shopping list management module 206. Generally, shopping list management module 206 is configured to manage shopping list data for a user of mobile device 201. Shopping list management module 206 can be used to perform shopping list related operations, such as, for example, adding shopping list items, checking off shopping list items, removing shopping list items, sorting shopping list items, searching shopping list items, itemizing shopping list items, etc. in response to user-entered commands. Shopping list management module 206 is also associated with application ID 231. Application ID 231 can be a unique ID used to distinguish shopping list management module 206 (and thus also mobile device 201) from other shopping list management modules (and thus also from other mobile devices). Application ID 231 can be assigned to mobile device 201 or derived from user related information, such as, for example, a telephone number, a loyalty card number, etc.

Shopping list management module 206 can present user-interface 219 at display 204 (e.g., a general purpose display device). User-interface 219 can include (e.g., touch screen) user-interface controls allowing a user to enter shopping list data and manipulate shopping list data. A user can enter input at user interface 219 to add items to the shopping list, sort the shopping list, check items off of the shopping list, etc. For example, customer 291 can enter input 292 to create shopping list 233. As depicted, shopping list 233 includes list entries 234A, 234B, 234C, etc. include item IDs 225AID, 225BID, 225CID, etc. Item IDs 225AID, 225BID, 225CID correspond to items 225A, 225B, and 225C in item database 222.

Shopping list management module 206 can also send notifications to customer location server 221 when shopping list entries have been checked off of or added to shopping list 233.

Communication module 203 can be a wireless network adapter for connecting mobile device 201 with a wireless network, such as, for example, Wi-Fi and/or a cellular network (e.g., CDMA, GSM, iDen, etc.) that facilitates a further connection to network 251 (e.g., the Internet).

Mobile device 201 can also access application server 261 which has access to item database 222. Application server 261 can be used to identify item IDs corresponding to items on shopping list 233. Alternatively, application server 261 can notify customer 291 if items on shopping list 233 cannot be located in item database 222. Furthermore, mobile device 201 can download item database 222.

A mobile device user can use application server 261 to resolve list entries. For example, mobile device 201 can send a generic item (textual) description to application server 261. Application server 261 can attempt to identify an appropriate item ID form item database 222. For example, mobile device 201 can submit list entry 234A to application server 261. Application server 261 can determine that list entry 234A corresponds to item 225A. As such, application server 261 can return item ID 225AID to mobile device 201. Mobile device 201 can the use item ID 225AID when sending notifications to customer location server 221.

In some embodiments, an entire shopping list is transmitted from a mobile device to customer location server 221 upon a customer entering the store. Customer location server 221 can cache the shopping list. Customer location server 221 can preprocess the shopping list to identify item locations within store map 229. Thus, when a notification of a checked off item is received, customer locating module 223 can more quickly determine a customer's location.

Mobile device 201 can also cache a shopping list to facilitate more efficient processing.

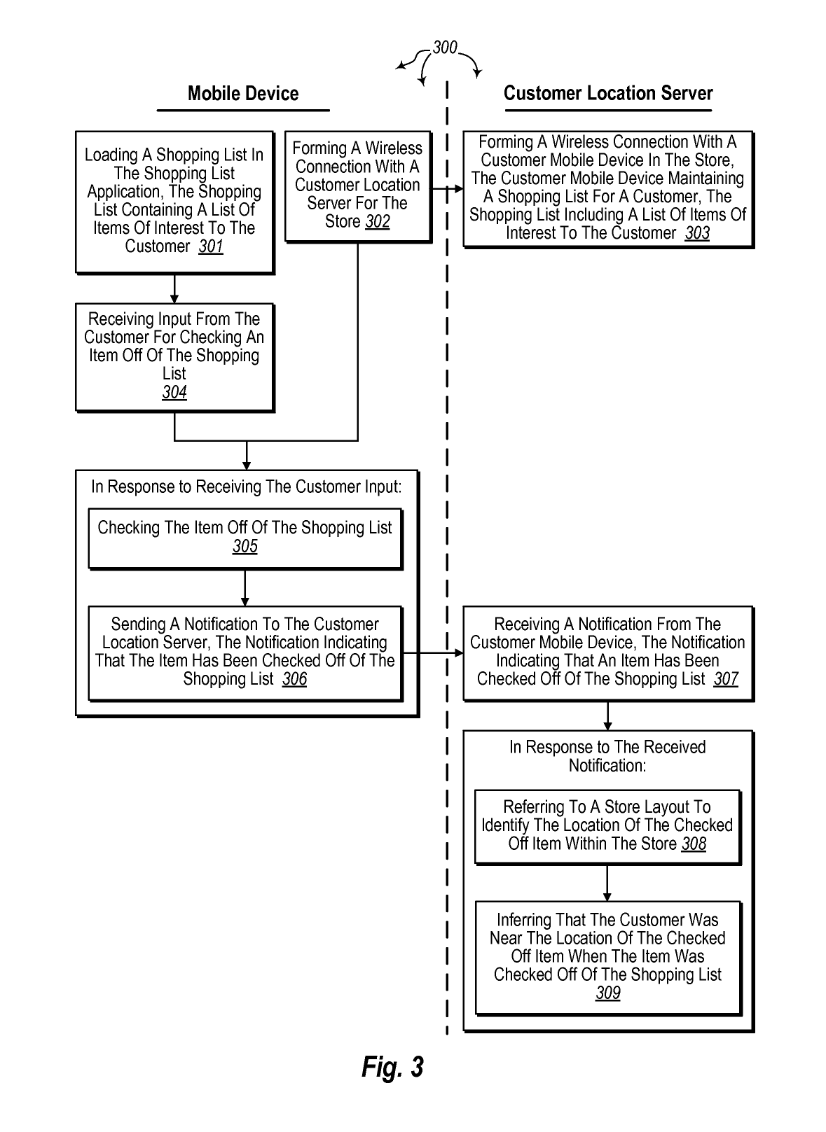

FIG. 3 illustrates a flow chart of an example method 300 for approximating customer location within a store. Method 300 will be described with respect to the components and data of computer architecture 200.

Method 300 includes loading a shopping list in the shopping list application, the shopping list containing a list of items of inters to the customer (301). For example, customer 291 can enter input 292 to load shopping list 233 in shopping list management module 206. Once shopping list 233 has been created, customer 291 can add items to shopping list 233, or remove items from shopping list 233 via user interface 219. For example, through user interface 219, customer 291 can add items 234A, 234B, 234C, etc. to shopping list 233.

In some embodiments, customer 291 can create shopping list 233, or add items to shopping list 233 via a web interface. For example, customer 291 may have created shopping list on a computer at home or at work and uploaded the list to an application server, such as, for example, application server 261. Customer 291 can then download shopping list 233 from application server 261 to mobile device 201.

Method 300 includes forming a wireless connection with a customer location server for the store (302). Method 300 includes forming a wireless connection with a customer mobile device in the store, the customer mobile device maintaining a shopping list for a customer, the shopping list including a list of items of interest to the customer (303). For example, mobile device 201 and customer location server 221 can form a wireless connection with one another. In some embodiments, after forming a wireless connection, shopping list management module 206 sends notification 240, including application ID 231 and shopping list 233 to customer location server 221. Upon receiving shopping list 233, customer location server 221 can cross-reference each item on shopping list 233 with store item database 222. This can facilitate faster processing for locating customer 291 when the customer checks an item off of shopping list 233.

Method 300 includes receiving input from the customer for checking an item off of the shopping list (304). For example, shopping list management module can receive input 292 for checking off list entry 234A. Customer 291 can enter input 292 in response to physically retrieving an item (e.g., item 225) within the store. Method 300 includes, in response to receiving the customer input, checking the item off of the shopping list (305). For example, shopping list management module 206 can check list entry 234A off of shopping list 233. Checking of list entry 234A indicates that the item (i.e., item 225) indicated in list entry 234A has been obtained.

Method 300 includes, also in response to receiving the customer input, sending a notification to the customer location server, the notification indicating that the item has been checked off of the shopping list (306). Method 300 includes receiving a notification from the customer mobile device, the notification indicating that an item has been checked off of the shopping list (307). For example, in response to list entry 234A being checked off of shopping list 233, shopping list management module 206 can send notification 239 to customer location server 221. Notification 239 includes application ID 231 and item ID 225AID. Application ID 231 identifies mobile device as the sender of the notification. Item ID 225AID indicates the item 225A was checked off of shopping list 233. Customer location server 221 can receive notification 239, including application ID 231 and item ID 225AID, from mobile device 201.

Also, in response to receiving customer input, mobile device 201 and/or customer location server 421 can optionally infer that customer 491 has taken possession of item 225A.

Method 300 includes, in response to the received notification, referring to a store layout to identify the location of the checked off item within the store (308). For example, customer locating module 223 can pass item ID 225AID to database access module 263. Customer locating module 223 can utilize database module 263 to access item database 222. Customer locating module 223 can refer to item database 222 to determine that item ID 225AID corresponds to item 225A and that item 225A is located at location 225AL. Database access module 263 can return location 225AL to store map module 224. Store map module 224 can identify location 225AL on store map 229.

Method 300 includes, also in response to the received notification, inferring that the customer was near the location of the checked off item when the item was checked off of the shopping list (309). For example, store map module 224 can use location 225AL to determine the location of item 225A within store map 229. Based on application ID 231, customer locating module 223 can infer that mobile device 201 (and thus customer 291) is near location 225AL since item 225A was recently checked off of shopping list 233.

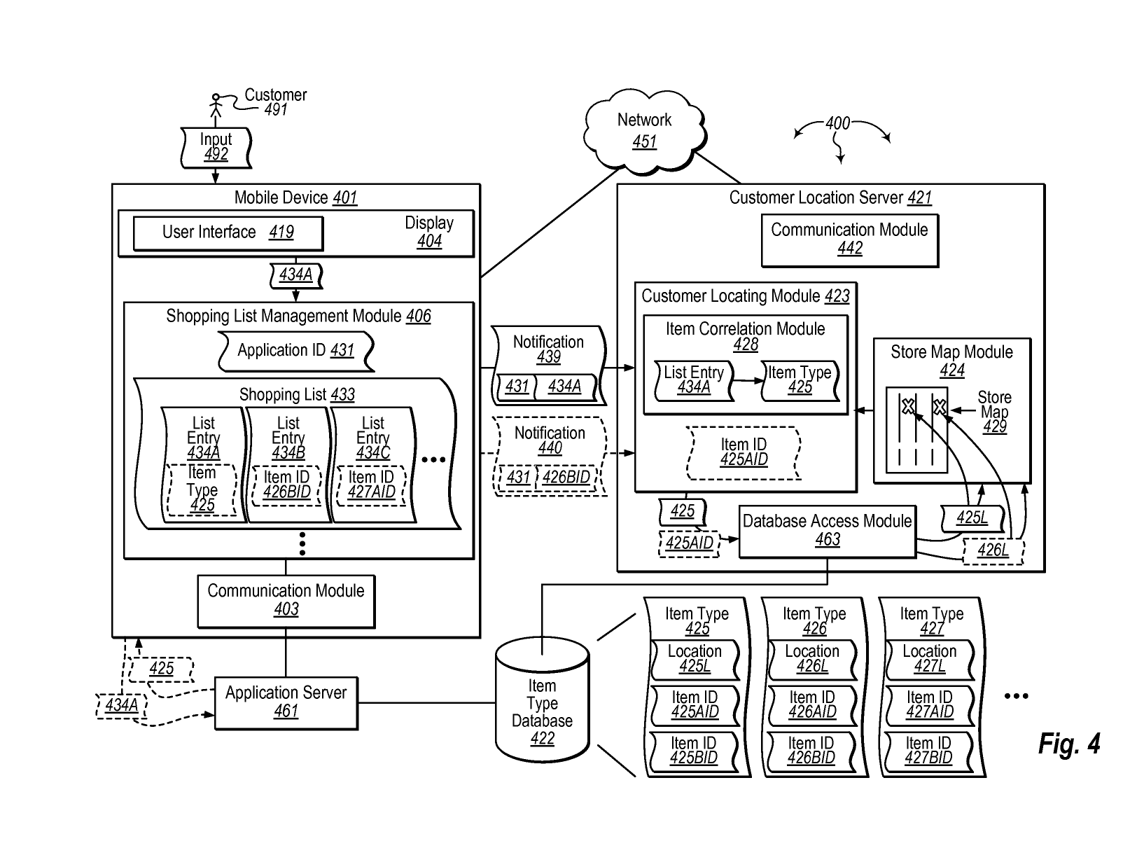

FIG. 4 illustrates an example computer architecture 400 that facilitates for approximating customer location within a store. Referring to FIG. 4, computer architecture 400 includes mobile device 401, customer location server 421, item type database 422, and application server 461. Each of mobile device 401, customer location server 421, item type database 422, and application server 461 as well as their respective components can be connected to one another over (or be part of) a network, such as, for example, a PAN, a LAN, a WAN, and even the Internet. Accordingly, each of mobile device 401, customer location server 421, item type database 422, and application server 461 as well as any other connected computer systems and their components, can create message related data and exchange message related data (e.g., near field communication (NFC) payloads, Bluetooth packets, Internet Protocol (IP) datagrams and other higher layer protocols that utilize IP datagrams, such as, Transmission Control Protocol (TCP), Hypertext Transfer Protocol (HTTP), Simple Mail Transfer Protocol (SMTP), etc.) over the network.

Customer location server 421 is configured similar to customer location server 221. Customer 421 is configured to infer a customer location within a store. Customer location server 421 includes communication module 442, customer locating module 423, store map module 424, and database access module 463. Communication module 442 can be a wireless network adapter for connecting customer location server 421 to network 451, such as, for example, a Wi-Fi network, within a store.

Customer locating module 423 is configured to receive notifications of items checked off shopping lists. Customer locating module 423 can refer to item type database 422 (through database access module 463) to identify a corresponding location for an item. Store map module 424 can then identify the item location on map 429. Store map module 424 can send the identified item location back to customer locating module 423. Customer locating module can infer that a customer is at or near to an identified item location based on an item being checked off a shopping list.

Store map module 424 can maintain store map 429 (or layout) of the store, including, but not limited to, the number and location of aisles, the location of point of sale systems, the location of departments, etc. Database access module 463 is configured to maintain (e.g., access, store, update, etc.) data in item type database 422. Item type database 422 can contain item information, including item types (milk, peanut butter, etc.), items that are of the item types (e.g., different types of milk, different types of peanut butter, etc.), and item type location. Item type database 422 can configured with knowledge that similarly typed items are located in proximity to one another within the store.

For example, item type database can include information for item types 425, 426, 427, etc. Item information for item type 425 includes item IDs 425AID and 425BID (identifying items of item type 425) and location 425L (the location of items of item type 425 within the store). Item information for item type 426 includes item IDs 426AID and 426BID (identifying items of item type 426) and location 426L (the location of items of item type 426 within the store). Item information for item type 427 includes item IDs 427AID and 427BID (identifying items of item type 427) and location 427L (the location of items of item type 427 within the store).

Mobile device 401 is configured similar to mobile device 201, mobile device 401 (e.g., a smartphone) includes communication module 403, display 404, and shopping list management module 406. Generally, shopping list management module 406 is configured to manage shopping list data for a user of mobile device 401. Shopping list management module 406 can be used to perform shopping list related operations, such as, for example, adding shopping list items, checking off shopping list items, removing shopping list items, sorting shopping list items, searching shopping list items, itemizing shopping list items, etc. in response to user-entered commands. Shopping list management module 406 is also associated with application ID 431. Application ID 431 can be a unique ID used to distinguish shopping list management module 406 (and thus also mobile device 401) from other shopping list management modules (and thus also from other mobile devices). Application ID 431 can be assigned to mobile device 401 or derived from user related information, such as, for example, a telephone number, a loyalty card number, etc.

Shopping list management module 406 can present user-interface 419 at display 404 (e.g., a general purpose display device). User-interface 419 can include (e.g., touch screen) user-interface controls allowing a user to enter shopping list data and manipulate shopping list data.

A user can enter input at user interface 419 to add items to the shopping list, sort the shopping list, check items off of the shopping list, etc. For example, customer 491 can enter input 492 to create shopping list 433. As depicted, shopping list 433 includes list entries 434A, 434B, 433C, etc. In some embodiments, list entries 434A, 434B, 433C, etc. contain textual descriptions of items, such as, for example, cereal, bread, ice cream, etc. In other embodiments, alternately and/or in combination, list entries 434A, 434B, 433C, etc. include specified item types, such as, for example, item type 425. In other embodiments, alternately and/or in combination, list entries 434A, 434B, 433C, etc. specified item IDs, such as, for example, item IDs 426BID and 427AID. Item IDs 426BID and 427AID correspond to item types 426 and 427 in item type database 422.

Shopping list management module 406 can also send notifications to customer location server 421 when list entries have been checked off of or added to shopping list 433.

Communication module 403 can be a wireless network adapter for connecting mobile device 401 with a wireless network, such as, for example, Wi-Fi and/or a cellular network (e.g., CDMA, GSM, iDen, etc.) that facilitates a further connection to network 451 (e.g., the Internet).

Mobile device 401 can also access application server 461 which has access to item type database 422. Application server 461 can be used to identify item IDs and/or item types corresponding to items on shopping list 433. Alternatively, application server 461 can notify customer 491 if items on shopping list 433 cannot be located in item database 422. Furthermore, mobile device 401 can download item database 422.

A mobile device user can use application server 461 to resolve list entries. For example, mobile device 401 can send a generic item (textual) description to application server 461. Application server 461 can attempt to identify an appropriate item ID or item type from item type database 422. For example, mobile device 401 can submit list entry 434A to application server 461. Application server 461 can determine that list entry 434A corresponds to item type 425. As such, application server 461 can return item type 425 to mobile device 401. Mobile device 401 can then use item type 425 when sending notifications to customer location server 421.

As depicted, mobile device 401 can send notification 439, including application ID 431 and list entry 434A (e.g., a text description of an item), to customer location server 421. Notification 439 can be sent in response to customer 491 checking off list entry 434A from shopping list 433. Notification 429 can optionally include item type 425 (either with or without a text description). Item type 425 may have previously been obtained from application server 4621.

Customer location server 421 can receive notification 439 from mobile device 401. In response to receiving the notification 439, item correlation module 428 can correlate list entry 434A with its appropriate item type in store item type database 422. For example, item correlation module 428 can determine that list entry 434A is associated with item type 425. Correlation module 428 can be bypassed when notification 439 includes item type 425.

Customer locating module 423 can pass item type 425 to database access module 263. Customer locating module 423 can utilize database module 463 to access item type database 422. Customer locating module 423 can refer to item type database 422 to determine that (items of) item type 425 is located at location 425L. Database access module 463 can return location 425L to store map module 424.

Store map module 424 can identify location 425L on store map 429. Based on application ID 431, customer locating module 423 can infer that mobile device 401 (and thus customer 491) is near location 425L since an item of item type 425 was recently checked off shopping list 433.

Alternately, mobile device 401 can send notification 440, including application ID 431 and item ID 426BID, to customer location server 421. Notification 440 can be sent in response to customer 491 checking off list entry 434B from shopping list 433. Customer location server 421 can receive notification 440 from mobile device 401. Customer locating module 423 can pass item ID 426BID to database access module 463. Customer locating module 423 can utilize database module 463 to access item type database 422. Customer locating module 423 can refer to item type database 422 to determine that item ID 426BID corresponds to item type 426 and that items of item type 426 are located at location 426. Database access module 263 can return location 426L to store map module 424.

Store map module 424 can identify location 426L on store map 429. Based on application ID 431, customer locating module 423 can infer that mobile device 401 (and thus customer 491) is near location 426L since an item of item type 426 was recently checked off shopping list 433.

Although the components and modules illustrated herein are shown and described in a particular arrangement, the arrangement of components and modules may be altered to process data in a different manner. In other embodiments, one or more additional components or modules may be added to the described systems, and one or more components or modules may be removed from the described systems. Alternate embodiments may combine two or more of the described components or modules into a single component or module.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. At a computer system, the computer system including one or more processors and system memory, the computer system maintaining a store layout for a store, the store layout indicating the location of items within the store, the computer system able to communicate with mobile devices in the store via a wireless connection, a method for approximating the location of a customer within the store, the method comprising;
forming a wireless connection with a customer mobile device in the store, the customer mobile device maintaining a shopping list for a customer, the shopping list including a list of items of interest to the customer;
receiving a notification from the customer mobile device, the notification indicating that an item on the shopping list has been checked off of the shopping list;
in response to receiving the notification, referring to the store layout to identify the location of the checked off item within the store; and
inferring that the customer was near the location of the checked off item when the item was checked off of the shopping list.

2. The method of claim 1, wherein the store layout is expressly stored and managed by a store mapping application resident at the computer system.

3. The method as recited in claim 1, further comprising:
receiving a copy of the shopping list from the customer mobile device;
in response to receiving the copy of the shopping list, determining the location of the items on the shopping list within the store; and

4. The method claim 3, further comprising caching the location of item on the shopping list.

5. The method of claim 3, wherein receiving a copy of the shopping list comprises receiving a copy of the shopping list from a shopping list application resident at the customer mobile device.

6. The method of claim 3, further comprising, subsequent to receiving a copy of the shopping list, receiving a notification from the customer mobile device that an additional item has been added to the shopping list.

7. The method of claim 1, wherein receiving a notification from the customer mobile device comprises receiving a notification that includes an item identifier; and
further comprising referring to an item database to identify the location of an item corresponding to the item identifier within the store.

8. The method claim 1, wherein receiving a notification from the customer mobile device comprises receiving a textual description of an item; and further comprising:
correlating the textual description to an item type; and
referring to an item type database to identify the location of items of the item type within the store.

9. The method claim 1, wherein receiving a notification from the customer mobile device comprises receiving a receiving a notification that includes an item identifier; and further comprising referring to an item type database to:
identify an item type corresponding to the item identifier;
determining the location of items of the item type within the store.

10. The method of claim 1, wherein receiving a notification that an item has been checked off of the customer shopping list comprises receiving a notification from a shopping list application resident at a mobile device.

11. At a mobile device for a customer, the mobile device including one or more processors and system memory, the mobile device containing a shopping list application, the shopping list application configured to manage shopping lists for the customer, the mobile device able to communicate with other computer systems via a wireless connection, a method for approximating a custom location within the store, the method comprising:
loading a shopping list in the shopping list application, the shopping list containing a list of items of interest to the customer;
forming a wireless connection with a customer location server for the store;
receiving input from the customer for checking an item off of the shopping list; and
in response to receiving the customer input:
checking the item off of the shopping list;
inferring that the customer has taken physical possession of the item;
sending a notification to the customer location server, the notification indicating that the item has been checked off of the shopping list.

12. The method of claim 11, wherein sending a copy of the customer shopping list comprises sending a copy of the shopping list from a shopping list application resident at a mobile device.

13. The method of claim 12, further comprising subsequent to sending the shopping list to the customer location server, sending a notification from the customer mobile device that an additional item has been added to the shopping list.

14. The method of claim 11, wherein a sending a notification to the customer location server comprises sending a notification that includes an application ID and an item ID.

15. The method of claim 11, wherein a sending a notification to the customer location server comprises sending a notification that includes an application ID and a textual description of an item.

16. The method of claim 11, wherein a sending a notification to the customer location server comprises sending a notification that includes an application ID and an item type.

17. The method of claim 16, further comprising prior to sending the notification:
sending a textual description of an item to an application server; and
receiving an item type for the item back from the application server.

18. A system for approximating a customer location within a store, the system comprising: a mobile device and a customer location server,
the mobile device comprising:
one or more processors;
system memory;
a network adapter;
one or more computer storage media having stored thereon computer-executable instructions that, when executed, cause the mobile device to:
load a shopping list in the shopping list application, the shopping list containing a list of items of interest to the customer;
form a wireless connection with the customer location server for the store;
receive input from the customer for checking an item off of the shopping list; and
in response to receiving the customer input:
check the item off of the shopping list; and
send a notification to the customer location server, the notification indicating that the item has been checked off of the shopping list; and
the customer location server comprising:
one or more processors;
system memory;
a network adapter;
one or more computer storage media having stored thereon computer-executable instructions that, when executed, cause the customer location server to:
form a wireless connection with the customer mobile device;
receive the notification from the customer mobile device;
in response to receiving the notification, refer to a store layout to identify the location of the checked off item within the store; and
infer that the customer was near the location of the checked off item when the item was checked off of the shopping list.

19. The system of claim 18, wherein computer-executable instructions that, when executed cause the mobile device to send a notification comprise computer-executable instructions that, when executed cause the mobile device to send a notification including an application ID for the mobile device and at least one of: an item ID, an item type, or a textual description of an item.

20. The system of claim 18, wherein computer-executable instructions that, when executed cause the mobile device to receive the notification from the customer mobile device comprise computer-executable instructions that, when executed cause the mobile device to receipt a notification including an application ID for the mobile device and at least one of: an item ID, an item type, or a textual description of an item.
